(19) United States
(12) Patent Application Publication
(10) Pub. No.: US 2018/0025077 A1
(43) Pub. Date: Jan. 25, 2018

(54) PROVIDING PERPETUAL MEDIA GEO-SYNCHRONIZATION

(71) Applicant: International Business Machines Corporation, Armonk, NY (US)

(72) Inventors: Luis C. Cruz Huertas, San Pedro (CR); Rick A. Hamilton, II, Charlottesville, VA (US); Shawn P. Mullen, Buda, TX (US); Edgar A. Zamora Duran, Heredia (CR)

(21) Appl. No.: 15/214,793

(22) Filed: Jul. 20, 2016

(51) Int. Cl. G06F 17/30; G06F 3/16; H04R 1/08; H04R 29/00

(52) U.S. Cl. CPC G06F 17/30752; H04R 29/00; G06F 3/165; H04R 1/08; G06F 17/30867; G06F 17/30772; G06F 17/30743

(57) ABSTRACT

A processor may sample a surrounding environment for an identifiable media in response to an activation event. The processor may determine, based on the sampling, whether an identifiable media was detected. The processor may generate reference indicators from environmental conditions. The processor may tag the identifiable media with one or more reference indicators associated with the environmental conditions. The processor may transmit a segment of the identifiable media to a media identification application. The processor may receive information about the identifiable media.

### BACKGROUND

The present disclosure relates generally to the field of media identification, and more specifically to storing and retrieving information for identifiable media.

A user may be in an atmosphere in which the user wants to remember particular information about the atmosphere. The user may try to use a device to identify and store the particular information. The interaction between the user and the device may take minutes to complete with the user having to handle the device and then the device storing the particular information.

### SUMMARY

Embodiments of the present invention disclose a method, computer program product, and system for identifying an identifiable media in response to an activation event in a surrounding environment. A processor may sample a surrounding environment for an identifiable media in response to an activation event. The processor may determine, based on the sampling, whether an identifiable media was detected. The processor may generate reference indicators from environmental. The processor may tag the identifiable media with one or more reference indicators associated with the environmental conditions. The processor may transmit a segment of the identifiable media to a media identification application. The processor may receive information about the identifiable media.

In some embodiments of the present invention, a system may receive one or more reference indicators for an identifiable media and a segment of the identifiable media from a device. The system may identify the identifiable media with a media identification application. The media identification application may produce a name indicator for the identifiable media. The system may store the one or more reference indicators associated with the identifiable media and the name indicator in a database table.

The above summary is not intended to describe each illustrated embodiment or every implementation of the present disclosure.

### BRIEF DESCRIPTION OF THE DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 illustrates a flowchart depicting an example method for tagging an identifiable media with reference indicators, in accordance with embodiments of the present disclosure.

FIG. 2 illustrates a flowchart of an example method for storing one or more reference indicators and a name indicator associated with an identifiable media, in accordance with embodiments of the present disclosure.

FIG. 3 illustrates a flowchart of an example system for a device to access information about the identifiable media, in accordance with embodiments of the present disclosure.

FIG. 4 depicts a cloud computing environment, in accordance with embodiments of the present disclosure.

FIG. 5 depicts abstraction model layers, in accordance with embodiments of the present disclosure.

FIG. 6 illustrates a high-level block diagram of an example computer system that may be used in implementing one or more of the methods, tools, and modules, and any related functions, described herein, in accordance with embodiments of the present disclosure.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to the field of media identification, and more specifically to storing and retrieving information for identifiable media. While the present disclosure is not necessarily limited to such applications, various aspects of the disclosure may be appreciated through a discussion of various examples using this context.

During the course of a day, a user may be in multiple environments (e.g., in a car, a dance club, a movie festival, at work, etc.), each of which may have a distinctive feel created by media specific to the environment (e.g., background noise, sights, smells, etc.). The user may be particularly fond of the feel of one environment or experience associated with the environment and wish to have the nostalgia of that location or experience again. For example, a user may have visited a Country Music Festival where the user may have heard “Great Country Song.” The user may find “Great Country Song” particularly relaxing and wish to hear “Great Country Song” on the user's drive to work in a congested city.

In some embodiments, a processor on a mobile device may sample short segments of media at periodic intervals. The processor may determine a media identifier (e.g., a name indicator, a time indicator, a date indicator, a location indicator, etc.) for each of the sampled short segments using known media identification services. The processor may create a media record (e.g., an entry in a database table) for each media identifier (also referred to herein as reference indicators) by associating each media identifier with a location and/or timestamp that corresponds with where and when the short segments were sampled. The processor may store the media records for later use. The processor may receive via a user interface, and at a later time, a query for results from among the stored media records. The processor may then display the results in response to the query. The query criteria may be for a particular media identifier, location, and/or timestamp (e.g. reference indicators that may include a name indicator, location indicator, date indicator, time indicator, etc.).

In some embodiments, a processor (e.g., in a computer system) may have sampled a surrounding environment for an identifiable media (throughout the disclosure an identifiable media is used to refer to both a singular medium and a plurality of media, for instance, a combination of one or more sights, sounds, etc.) in response to an activation event (e.g., vibration, movement, a timer, etc.). In some embodiments, the activation event may be a timer set to activate a microphone at a predetermined time associated with a sampling rate when the timer expires. The processor may also determine, based on the sampling, whether an identifiable media was detected.

For example, while in Central Europe, a user may have a mobile device, which may have an application installed that has a timer. The timer may expire and trigger a processor to activate a microphone on the mobile device every five minutes (e.g., a sampling rate). The processor may determine, through the microphone, that an identifiable media (e.g., Polka music) is detected in the surrounding environment that the user is in.

In some embodiments, the processor may identify the identifiable media as at least one object in the surrounding environment having searchable media attributes (e.g., a repetitive beat, a rhythm, visual cues, distinctive animal noises, smells, etc.). In some embodiments, the processor may increase the sampling rate of the surrounding environment in response to identifying the identifiable media.

For example, the processor on the mobile device may identify a violin playing as an identifiable media having searchable attributes. The searchable attributes may be the tone and pitch of the violin. The processor may increase the sampling rate of the surrounding environment from every five minutes to every two minutes in response to detecting the searchable attributes. The processor may increase the sampling rate in order to sample the surrounding environment more often and allow the processor to detect more identifiable media (e.g., the processor may determine it is in a high-activity environment and increase the sampling rate in order to not miss a relevant identifiable media in the surrounding environment).

In some embodiments, the processor may stop sampling the surrounding environment if the processor detects a personal conversation or other sensitive media/communication. For example, a user may be in a restaurant and a processor on a mobile device owned by the user may begin to sample the surrounding environment. The processor may be programmed to distinguish between human voices not audio-enhanced (e.g., humans talking in a restaurant, etc.) and audio-enhanced human voices (e.g., a singer live-singing through a microphone, a singer auto-tuned on a compact disc, a movie star giving a speech in a movie, etc.). The processor may determine that there are only non-audio-enhanced human voices with no searchable attributes in the surrounding area and stop sampling. The processor may determine there are no searchable attributes because there may be no distinguishing characteristics indicative of an identifiable media (e.g., rhythms, beats, pitches, above-normal decibel levels of noise, audio-enhancement of voices, crackling from a microphone, etc.). The processor may stop sampling in order to preserve the privacy of the user and other persons in the surrounding environment.

In some embodiments, the processor may stop sampling the surrounding environment when a threshold media level is not met. For example, a user may be in a restaurant with ambient violin music playing. A processor may begin sampling the surround environment and detect the violin music and the user talking. The processor may stop sampling because the violin music is not above a threshold decibel level, such as 65 decibels. The processor may determine that the user is in an environment that is more suited for private conversation than environmental stimuli like music, and stop sampling.

In some embodiments, when sampling the surrounding environment, the processor may save the sample in a memory (e.g., RAM, cache, etc.). In some embodiments, the processor may delete the sample if no identifiable media is detected. This may be done in order to protect the privacy of the user or other persons in the surrounding environment. In some embodiments, the processor may delete the sample immediately after an identifiable media is detected.

For example, a processor on a cellphone owned by a user may begin sampling a surrounding environment. The sample may include numerous voices and an identifiable media. The processor may store the sample in a memory and transmit a copy of the sample to a media identification application. The media identification application may detect the identifiable media and indicate to the processor that the identifiable media was detected by transmitting the identity of the identifiable media. Upon receiving the identity of the identifiable media (e.g., indicating that an identifiable media was detected), the processor may immediately delete the sample of the surrounding environment. The processor may also store the identity (e.g., name) of the identifiable media in the memory. The immediate deletion of the sample may be done in order to protect the privacy of the user and other persons in the surrounding environment.

In some embodiments, the processor may decrease the sampling rate if only human voices are identified in the surrounding environment. For example, a timer may be set to activate a processor in a mobile device to sample the surrounding environment every 10 minutes. The processor may sample the surrounding environment and only identify two human voices, which are not in a harmonic tone (e.g., not singing), and stop sampling. The processor may also decrease the sampling rate on the timer from 10 minutes to 30 minutes to give the conversationalists privacy.

In some embodiments, the activation event may be the processor activating a device in response to a gyroscope in the mobile device detecting vibration in the surrounding environment. For example, a user may be at a concert, a processor in a mobile device owned by the user may detect that the gyroscope in the mobile device is vibrating in a constant, reoccurring rhythm (e.g., much like a beat associated with a song). The processor may activate a microphone in the mobile device to sample for an identifiable media.

In some embodiments, the activation event may be the processor activating a wearable device (e.g., smart watch, headphones, etc.) in response to detecting the wearable device moving in a non-standard motion. For example, the processor may determine the standard gait of a user by determining metrics sent from a wearable device worn by the user. The user may go to a dance concert, and the processor may determine that the wearable device is moving (e.g., due to the user dancing) in a non-standard gait in relation to the usual swing of the user's arm while walking. The processor, in response to determining the non-standard gait, may activate a microphone on the wearable device to start sampling the surrounding environment. In some embodiments, the wearable device may be connected to a mobile device and the processor may activate the mobile device in response to detecting a non-standard motion of the wearable device.

In some embodiments, the wearable device may have a heart rate monitor and the activation event may be the processor detecting an elevation in the heart rate of a user. For example, a processor may determine from a wearable device that has a heart rate monitor and is connected to a mobile device owned by a user, that the user has a normal heart rate of 78 beats per minute (BPM). The processor may be set to activate the mobile device to sample the surrounding area when the user's heart rate increases by a threshold amount, such as 20% (e.g., goes up to 94 BPM). The user may be dancing at a Rock Concert and the user's heart rate may go up to 103 BPM. The processor may detect the elevation in heart rate from the heart rate monitor in the wearable device and activate the mobile device to start sampling the surrounding environment. In some embodiments, the threshold may be set by a user or heuristically by the processor using historical data.

In some embodiments, the processor may also determine reference indicators from environmental conditions. The processor may tag the identifiable media with one or more reference indicators based on the environmental conditions. For example, the processor may be on a mobile device that tracks time, date, and location via a global positioning system (GPS) locator. The processor may determine that the environmental conditions of time, date, and location should be used as reference indicators for the identifiable media and tag the identifiable media with a time indicator, a date indicator, and a location indicator.

In some embodiments, the reference indicators and associated identifiable media are populated into a database table in order for a user or the processor to quickly search for the identifiable media. The database table may be associated with a user (e.g., created using user account on an application service, etc.) and usable from any device associated with the user (e.g., cellphone, tablet, computer, etc.). In other embodiments, tagging the identifiable media with the reference indicators involves storing the identifiable media and reference indicators in the same database table (e.g., in a media record). In some embodiments, the processor may transmit a segment of the identifiable media to a media identification application. In some embodiments, the processor may also generate a fingerprint of searchable media attributes associated with the identifiable media and transmit the fingerprint to the media identification application. The processor may then receive information about the identifiable media back from the media identification application.

In some embodiments, the information received back may include the identity of the identifiable media (e.g., the name of the identifiable media). In some embodiments, the information received back from the media identification application may be the identifiable media artist's name, media length, pixel quality, media form (e.g., mp3, wma, mpeg, gif, etc.), or any other quantifiable information. In some embodiments, the information received back is internally stored in memory as a database table. The database table may allow the user, the processor, and/or a system access to the information about the identifiable media at a later time (e.g., by querying the database table).

In some embodiments, the information received back from the media identification application may be a playlist including the identifiable media or all identifiable media identified during a set amount of time. For example, a media identification application may be set to create a playlist every 24 hours with all the identifiable media transmitted by a processor to the media identification application. Over the course of 24 hours, a user may have been in multiple places where the processor detected three identifiable media. The processor may send the three identifiable media to the media identification application, which may identify the identifiable media as “Jazz Song,” “Classical Song,” and “Music Song.” The media identification application may then create a playlist with all three identified songs and transmit the playlist to the processor. In some embodiments, the playlist may be stored in the database table or in an individual database table memory and transmitted at a later time and/or to another device associated with the user.

In some embodiments, the playlist may include one or more identifiable media. In some embodiments, the media identification application may use a media content provider (e.g., an application or service that allows access to full-length media segments) to create the playlist. For example, a processor may have detected an identifiable media in the background of a music festival from a mobile device owned by the user. The processor may open communication with a media identification application and transmit a segment of the identifiable media. The media identification application may identify the identifiable media as “Disco Song.” The media identification application may then transmit the name “Disco Song” to a media content provider. The media content provider may generate a playlist with the one song, “Disco Song,” on the playlist and transmit the playlist to the processor, thereby allowing the user to listen to the entire song. In some embodiments, the media identification application may transmit the identity (e.g., name) of the identifiable media back to the processor and the processor may forward the identity to the media content provider to create a playlist with the identifiable media.

In some embodiments, a processor may transmit one or more current environmental conditions to a remotely located server. The processor may determine that at least one of the one or more reference indicators approximately matches one or more current environmental conditions. The processor may prompt a user to play a song on a device in response to determining that at least one of the one or more reference indicators approximately matches one or more current environmental conditions. In some embodiments, the current environmental condition may be the current date approximately matching the date indicator (e.g., the month and day, but not the year of the current environmental conditions and the date indicator matching; sometimes referred to herein as an anniversary condition).

For example, a user may have been on a beach in Mexico on Jun. 15, 2013. While on the beach, a processor in the user's mobile device may have identified an identifiable media playing in the surrounding environment. The processor may have transmitted the segment of the identifiable media with a date indicator marking the identifiable media as found on Jun. 15, 2013 to a media identification application. On Jun. 15, 2014, a year later, the processor may transmit a current environmental condition (e.g., the current date) to a remotely located server. The processor may determine that an anniversary condition is met and receive (e.g., query, retrieve, etc.) from the media identification application that the identifiable media from Jun. 15, 2013, “Paradise Song” by Island Singer. The processor may prompt the user to play “Paradise Song” on the mobile device owned by the user. In some embodiments, the anniversary condition may be more or less than a year. In some embodiments, the processor may automatically play the song (e.g., identifiable media) on the mobile device.

In some embodiments, the current environmental condition may be the processor currently being within a threshold area/distance in relation to the location indicator. For example, the processor may have transmitted an identifiable media to a media identification application with a location indicator that references Phoenix, Ariz. The processor may determine that the user's mobile device is currently within 10 miles of the location indicator and receive information about the identifiable media and prompt the user to play the identifiable media on the mobile device owned by the user. In some embodiments, the location indicator may be a latitudinal and longitudinal coordinate.

In some embodiments, the current environmental condition may be the processor identifying that the time is within a threshold limit in relation to the time indicator. For example, a processor on a user owned mobile device (e.g., car radio) may transmit a segment of an identifiable media and a time indicator detailing 5:30 p.m. The time indicator may be associated with the user's routine drive home. The next day, the processor may determine that the time is currently 5:32 p.m. and receive information about a playlist with the user's favorite media from a remotely located server. The processor may also play the playlist on the user owned mobile device.

In some embodiments of the present invention, a system (e.g., server) may receive one or more reference indicators for an identifiable media and a segment of the identifiable media from a device. The server may identify the identifiable media with a media identification application. In some embodiments, the media identification application may generate a name indicator for the identifiable media. The server may also store the one or more reference indicators associated with the identifiable media and the name indicator (e.g., track name, artist name, album name, playlist name, etc.) in a database table. In some embodiments, the name indicator may be stored as a media record in the database table.

For example, a user may be at a film festival and a processor on a mobile device owned by the user may detect an identifiable media in the surrounding environment (e.g., a film). The processor may transmit a location indicator, time indicator, date indicator, and a segment of the identifiable media to a server. The server may receive the reference indicators and the segment of the identifiable media. The server may identify the identifiable media using a media identification application. In some embodiments, the media identification application may use the location indicator to determine that the identifiable media is within a threshold range of a film festival.

Additionally, the time indicator and date indicator may be used to identify possible show times of a film on the particular day the identifiable media is being sampled. The server may produce a name indicator for the identifiable media using the media identification application (e.g., the film was identified as “A Movie”). The server may store the time, date, location, and name indicators for later use by the user or other devices.

In some embodiments, the server may identify the identifiable media by receiving a searchable attribute associated with the identifiable media. In some embodiments, the searchable media attribute may be a fingerprint (e.g., a spectrogram or fast Fourier transform of the media) used to locate the name indicator associated with the identifiable media. For example, the server may receive a fingerprint of an identifiable media (e.g., a song). The server may compare the fingerprint to a database of known fingerprints to identify (e.g., name) the identifiable media. In some embodiments, the device may generate the fingerprint. In other embodiments, the server may generate the fingerprint.

In some embodiments, the media identification application may be housed in the server. For example, the server, upon receiving a searchable media attribute, may stream (e.g., transmit) the searchable media attribute to a media identification application that is installed in the server. That is, the media identification application may not be an outside component and identification may be done by the server using a media identification application.

The server may also receive the name indicator for the identifiable media from the media identification application. The server may transmit the name indicator to a media content provider. In some embodiments, the media content provider may be housed in the system. For example, the server may receive a name indicator, “Rock Song,” for an identifiable media using the media identification application. The server may transmit the name “Rock Song,” to a media content provider that may be installed in the system. That is, the media content provider may not be an outside component of the system, but may be a tool or module used by the server to complete a task.

The server may generate a playlist and list the identifiable media in the playlist. Following from the example above, the server may transmit the name “Rock Song,” to the media content provider and use the media content provider to find a full recording of “Rock Song.” The server may then generate a playlist that includes “Rock Song,” as the identifiable media. The playlist may be generated in order for the user to easily access and remember the name of the identifiable media the user heard in a surrounding environment.

In some embodiments, the server may receive a current location indicator, a current time indicator, and a current date indicator from the mobile device. For example, a user of the mobile device may query for a song heard 5 years ago at the current location the user is at. The server may determine that at least one of the stored indicators approximately matches at least one of the current indicators. The server may then transmit the playlist to the device. In some embodiments, the server may have generated the playlist that includes the identifiable media. In some embodiments, the server is returned information about the identifiable media (e.g., a list of songs matching the query).

For example, an identifiable media, “Opera No. 5” may have been identified on Jan. 14, 2009, tagged with a date indicator detailing Jan. 14, 2009 as the date the identifiable media was first heard, and stored in a server. On Jan. 14, 2010, the server may transmit the information about Opera No. 5 to a device owned by a user. This may be done automatically (e.g., because the sever recognized the anniversary condition) or in response to a query. The user may decide to play Opera No. 5 on the device or may be reminded of the time the user was at the Opera Ballet. In some embodiments, the server may continue to transmit information to the user's device every subsequent year on the specified date (e.g., every January 14).

In some embodiments, the server may determine that a current location indicator approximately matches the stored location indicator for an identifiable media. For example, the server may have been transmitted an identifiable media (e.g., a “Fight Song”) from a location (e.g., a “State College Football Stadium”) A few weeks later, the server may determine from a current location indicator that a device owned by a user (e.g., a satellite radio in a car owned by the user) is 1 mile away from the State College Football Stadium and is driving towards the stadium. The server may transmit the Fight Song to the radio to prepare the user for the state college football atmosphere. In some embodiments, the server may determine that the current location indicator is within the same geographically named area as the location indicator (e.g., the server may determine that the current location indicator is in Minneapolis, Minn. and matches a stored location indicator from Minneapolis, Minn.).

In some embodiments, the server may determine that a current time indicator approximately matches a stored time indicator. For example, the server may have a stored time indicator for 11:00 p.m. that is associated with beach waves identified on a trip a user took to Jamaica. The server may compare the current time indicator (e.g., 10:59 p.m.) with the stored time indicator and determine that the current time indicator is within one minute of the stored time indicator. In response to determining that the current time indicator is within one minute of the stored time indicator, the server may transmit the ocean waves soundtrack to a wirelessly connected speaker owned by the user. The ocean waves may create a relaxing atmosphere that helps the user fall asleep.

In some embodiments, the server may transmit information about the identifiable media if the server determines that a combination of a current time indicator, current location indicator, and current date indicator approximately match a respective stored time indicator, stored location indicator, or stored date indicator. In some embodiments, the combination of current indicators may be any combination of two or more of the current indicators approximately matching respective stored indicators.

For example, a person may have proposed to their significant other on a Californian bluff, at 6:18 p.m. (e.g., sunset), on May 25, 2001. While proposing, the person may have had a romance song playing in the background, which the sever stored as an identifiable media with a time, date, and location indicator. Each indicator may respectively be associated with 6:18 p.m., May 25, and a Californian bluff. On May 25, 2011, the person may have taken their significant other back to the Californian bluff to reminisce about the proposal that happened a decade before. However, the person may have forgotten the exact song they had chosen to play in the background. The time may be 6:18 p.m. and the server may determine that the person is on the Californian bluff at 6:18 p.m. on May 25 and start playing the romance song on the mobile device owned by the person.

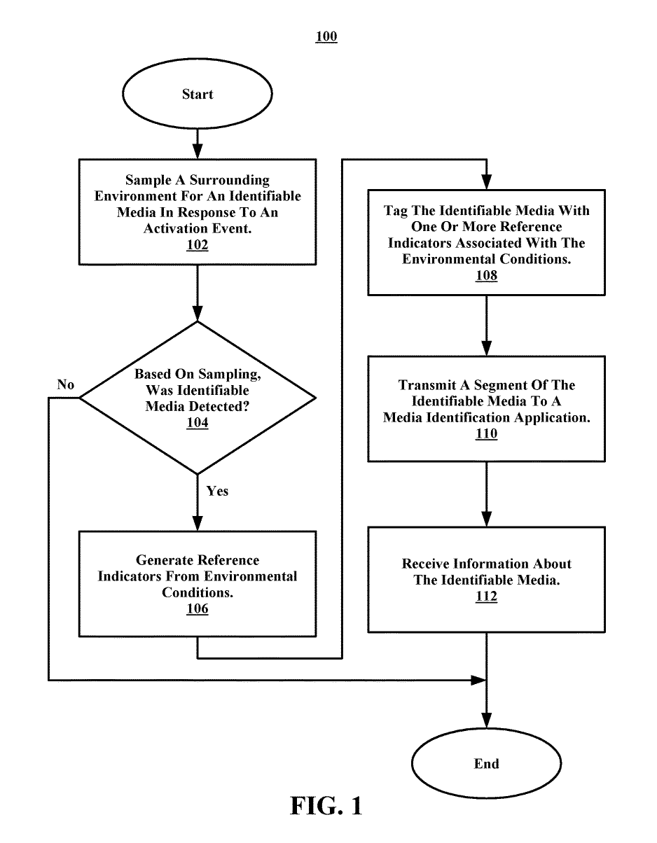

Referring now to FIG. 1, illustrated is a flowchart of an example method 100 for tagging an identifiable media with reference indicators, according to embodiments of the present disclosure. A processor on a device (e.g., smartphone, smart watch, computer, radio, etc.) may perform method 100. In some embodiments, a user may perform one or more operations in the method 100. In some embodiments, one or more operations in the method 100 may be performed by the processor in response to user input. The method 100 may begin at operation 102, where the processor may sample a surrounding environment for an identifiable media in response to an activation event. In some embodiments, sampling may be done by the processor activating a recording device (e.g., a microphone, a camera, etc.) in a user owned mobile device and streaming the identifiable media detected in the surrounding environment to a media identification application.

In some embodiments, the activation event may be user initiated. For example, a user may be on a dance floor with a particular song playing. The user may want to remember the atmosphere created while on the dance floor by the particular song. The user may shake their mobile device three times to activate a processor in the mobile device. The processor may activate a microphone on the mobile device and sample the surrounding environment (e.g., the dance floor for the particular song).

In some embodiments, the activation event may be the user pushing a button on the device. In some embodiments, the activation event may be the user setting specific times for the device to sample the surrounding environment. In some embodiments, the activation event may be the user setting a geofence (e.g., the user sets up a geographic boundary using a global positioning system) and the device samples the surrounding area whenever the device is inside or outside the geographic boundary.

In some embodiments, the activation event may be the processor identifying a rhythm. The processor may be set to only sample when the processor identifies a rhythm in the surrounding environment. This may help with privacy concerns when the user or other persons are in the surrounding area. For example, a user may be in crowded dining hall, the processor may not begin sampling because no rhythm is being detected, only the chattering of people in the surrounding environment. Whereas, the user may go to a concert after the restaurant and the processor may detect a rhythm from the band performing the concert and begin sampling the surrounding environment. In some embodiments, the activation event may be a timer programmed to activate a recording device upon expiration at the end of a sampling rate.

After sampling the surrounding environment for an identifiable media in response to an activation event at operation 102, the processor may determine, based on sampling, whether an identifiable media was detected at decision block 104. In some embodiments, the processor may determine that there is an identifiable media in the surrounding environment by identifying a searchable media attribute in the identifiable media. For example, the processor may identify a particular octave associated with a violin in the surrounding environment. The processor may determine that the octave is a searchable attribute of an identifiable media because an octave is indicative of music (e.g., the processor may determine there is an identifiable media by the octave in the surrounding environment).

In some embodiments, the processor may determine whether an identifiable media was detected by sending a segment of a possible identifiable media (or a fingerprint generated from the segment) to a media identification service. The media identification service may relay information back to the processor that the segment was part of an identifiable media. For example, a processor may begin sampling a surrounding environment and streaming what is heard in the surrounding environment to a media identification service. The media identification service may identify that one particular sound in the surrounding environment is apart of the song “Background Song.” The media identification service may transmit an indication to the processor that “Background Song” was identified in the surround environment. The processor may therefore determine that an identifiable media was detected. In some embodiments, the processor may increase a sampling rate in response to determining that an identifiable media was detected.

If at decision block 104 the processor determines there is no identifiable media, the method 100 may end. If at decision block 104 the processor determines that there is an identifiable media, the method 100 may continue to operation 106. At operation 106, the processor may generate reference indicators from environmental conditions. In some embodiments, the device includes the processor. In some embodiments, the environmental conditions include a location, a time, and a date.

For example, a processor on a mobile device may have determined that there is an identifiable media in a surrounding environment. To make note of when and where the identifiable media was detected, the processor may access a GPS locator, a clock, and a calendar on the mobile device. The processor may generate reference indicators associated with the environmental conditions from the device as tags indicating Rochester, Minn. from the GPS locator, 5:11 p.m. from the clock, and May 17, 2016 from the calendar. In some embodiments, the generated reference indicators may be stored in a database table (e.g., on a media record).

After generating reference indicators from environmental conditions at operation 106, the method 100 may continue to operation 108. At operation 108, the processor may tag the identifiable media with one or more reference indicators associated with the environmental conditions. In some embodiments, the tags associated with the one or more reference indicators may be segments of code embedded in the identifiable media. In some embodiments, the user may optionally create tags as reference indicators for the identifiable media.

For example, a user may want to remember a particular song that was heard on a vacation. A processor may have already tagged the identifiable media as “Jun. 11, 2009, 11:05 a.m., Canada,” but the user may want to label the identifiable media in their own terms and the user may create a personal tag for the identifiable media as “Best Vacation 2009.” This may allow the user to quickly locate the song heard on their 2009 vacation without having to recall the exact time, date, or location.

After tagging the identifiable media with one or more reference indicators associated with the environmental conditions at operation 108, the method 100 may continue to operation 110. At operation 110, the processor may transmit a segment of the identifiable media (or a fingerprint generated therefrom) to a media identification application. For example, a processor on a mobile device may determine that there is an identifiable media in a surrounding environment. The processor may activate a microphone on the mobile device and stream a segment of the identifiable media to a media identification application. In some embodiments, the segment of the identifiable media may be a segment within a threshold large enough for the media identification application to identify the identifiable media.

For example, a particular media identification application may require a 20 second segment of an identifiable media to correctly identify the identifiable media. The processor on the mobile device may only transmit a 20 second segment of the identifiable media to the media identification application. In some embodiments, the processor may continue transmitting a segment of the identifiable media to the media identification application until the media identification application alerts the processor to stop transmitting.

For example, a media identification application may require a 10 second segment to identify an identifiable media. The processor may start sampling a surrounding environment and transmit 30 seconds of the identifiable media before the media identification application alerts the processor to stop transmitting. In some embodiments, the alert may be the media identification application closing. In some embodiments, the alert may be the media identification application returning results (e.g., the identity of the identifiable media, the length of the identifiable media, etc.) about the identifiable media.

After transmitting a segment of the identifiable media to a media identification application at operation 110, the method 100 may continue to operation 112. At operation 112, the processor may receive information about the identifiable media. In some embodiments, the information about the identifiable media may include the name of the identifiable media, the length of time of the identifiable media, preview images of the identifiable media, the artist/composer of the identifiable media, the producer of the identifiable media, etc. In some embodiments, the processor may receive the information about the identifiable media from a system housing the media identification application.

For example, the media identification application may identify the identifiable media as “Country Song.” The identification application may also identify Country Song as a song that is 3 minutes and 21 seconds long and retrieve a picture of the lead singer of Country Song. The processor may receive the name of the identifiable media, “Country Song,” the length of Country song, 3 minutes and 21 seconds, and the preview image, the picture of the lead singer. In some embodiments, after receiving information about the identifiable media at operation 112, the method 100 may end. In some embodiments, after receiving information about the identifiable media at operation 112, the processor may transmit the information to a server to be stored as a media record in a database table. The database table may be associated with a device or user of a device. The media record may later be queried by a processor on a device used by the user or directly by the user.

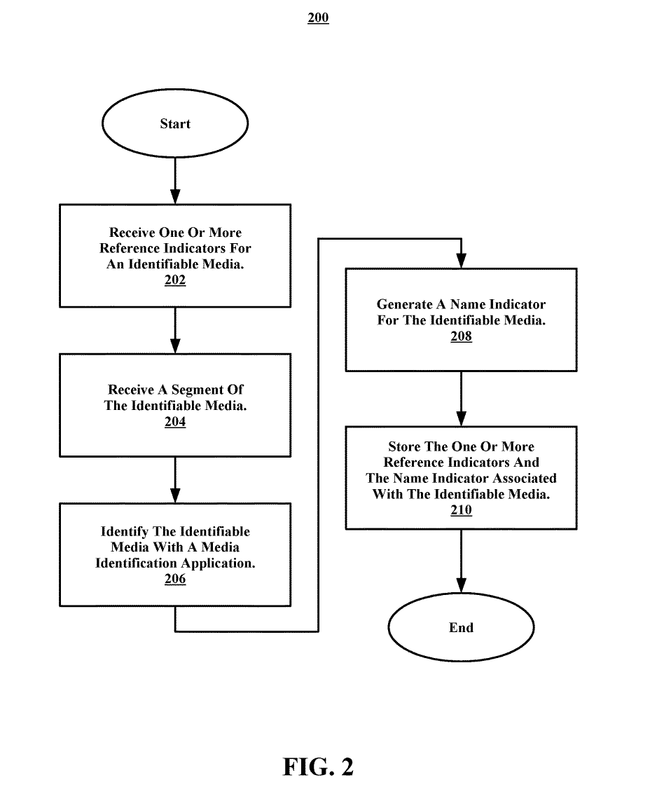

Referring now to FIG. 2, illustrated is a flowchart of an example method 200 for storing one or more reference indicators and a name indicator associated with an identifiable media, according to embodiments of the present disclosure. In some embodiments, a user may perform one or more operations in the method 200. In some embodiments, a computer system may perform one or more operations in the method 200. The method 200 may begin at operation 202, where a server may receive one or more reference indicators for an identifiable media. In some embodiments, the reference indicators are the same or substantially similar reference indicators discussed in reference to operations 106 and 108 in FIG. 1. In some embodiments, the server may receive one or more reference indicators from a mobile device used by a user.

After receiving the one or more reference indicators for the identifiable media at operation 202, the method 200 may continue to operation 204. At operation 204, the server may receive a segment of the identifiable media. In some embodiments, the server may receive the segment of the identifiable media at the same time as receiving the one or more reference indicators for the identifiable media. For example, the server may receive the one or more reference indicators as tags embedded in the segment of the identifiable media. While analyzing the identifiable media, the server may recognize the reference indicators and the segment as separate objects that were received at the same time.

In some embodiments, the server may receive the segment of the identifiable media and the one or more reference indicators as a prepopulated database table. For example, the server may receive a prepopulated database table in the form of Table 1, as detailed below.

TABLE 1

| | | | | | | | |
|---|---|---|---|---|---|---|---|
| Identifiable | | | | | Length of | | |
| Media | | | | | Identifiable | | Personal |
| Segment | Name | Location | Time | Date | Media | Picture | Tag |

| | | | | |
|---|---|---|---|---|
| “Media | Seattle, | 3:17 p.m. | Oct. 12, | “Oyster |
| with | Washington | | 2015 | Festival” |
| trumpet | | | | |
| every 6.323 | | | | |
| seconds” | | | | |

The prepopulated database table depicted in Table 1 may include a segment of the identifiable media (or a fingerprint), a location indicator, a time indicator, a date indicator, and a personal tag populated by a processor transmitting the package. In some embodiments, a user may populate the personal tag. In some embodiments, the prepopulated database table may leave a name indicator, a length of the identifiable media, and a picture cell open for the system to populate after identifying the identifiable media.

In some embodiments, when a segment of a new identifiable media is received, the server may update the prepopulated database table (e.g., with current media records) by adding new rows and columns to be used for the new identifiable media. In other words, a single database table may include a record for each identifiable media. In some embodiments, when a segment of a new identifiable media is received, the server may generate a new database table to populate with information about the new identifiable media.

After receiving a segment of the identifiable media at operation 204, the method 200 may continue to operation 206. At operation 206, the server may identify the identifiable media with a media identification application. In some embodiments, the media identification application may be stored on the server. For example, the server may receive a segment of an identifiable media. The server may direct the segment to a media identification application (e.g., module) stored on the server and the media identification application may identify the identifiable media.

After identifying the identifiable media with a media identification application at operation 206, the method 200 may continue to operation 208. At operation 208, the server may generate a name indicator for the identifiable media. In some embodiments, the server may generate a name indicator as a segment of code identified in the media identification application.

For example, a server may have identified an identified media as “Comic Book Movie,” using a media identification application. The server may access a library used by the media identification application and identify the segment of code used to identify the “Comic Book Movie.” The server may take the segment of code and generate a tag with the name “Comic Book Movie.” The tag may be associated with the identifiable media.

After generating a name indicator for the identifiable media at operation 208, the method 200 may continue to operation 210. At operation 210, the server may store the one or more reference indicators and the name indicator associated with the identifiable media. In some embodiments, the server may store the reference indicators and the name indicator in a library in the server.

For example, a server may have identified an identifiable media as “Great Song” on Jul. 22, 2013 at 4:23 p.m. in Atlanta, Ga. The server may store the name of the song, the date, the time, and the location of when the identifiable media was identified in a library. The library may be searchable and easily accessible by a user of the server at a later time.

In some embodiments, the server store the one or more reference indicators in the prepopulated database table discussed in reference to operation 204, as depicted in Table 2 below.

TABLE 2

| Identifiable | | | | | Length of | | |
|---|---|---|---|---|---|---|---|
| Media | | | | | Identifiable | | Personal |
| Segment | Name | Location | Time | Date | Media | Picture | Tag |
| “Media | “Pop | Seattle, | 3:17 p.m. | Oct. 12, | 2 minutes, | “Pop | “Oyster |
| with | Song” | Washington | | 2015 | 23 seconds | Star” | Festival” |
| trumpet | | | | | | | |
| every 6.323 | | | | | | | |
| seconds” | | | | | | | |

In some embodiments, Table 2 is the same as or substantially similar to Table 1. Table 2 may be the prepopulated database table discussed in operation 204 after the identifiable media was identified by the server. The server may have populated the unfilled cells from Table 1 with the missing information (e.g., the name of the identifiable media, the length of the identifiable media, and a picture of the composer of the identifiable media). In some embodiments, the server may send the database table back to a mobile device, which may store the database table locally or on a storage server.

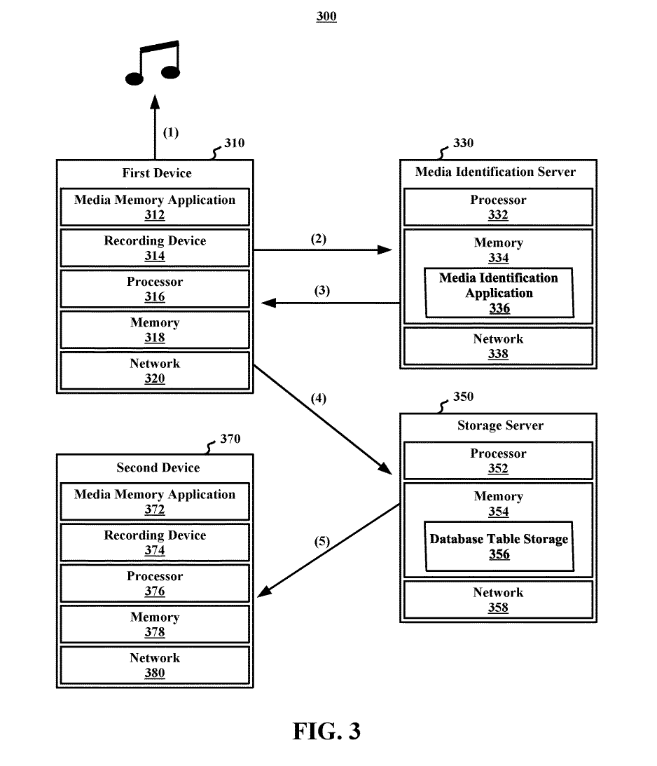

Referring now to FIG. 3, illustrated is a block diagram of an example system 300 for a device to access information about an identifiable media, according to embodiments of the present disclosure. The system 300 may include a first device 310, a second device 370, a media identification server 330, and a storage server 350.

Consistent with various embodiments, the first device 310 may include a media memory application 312, a recording device 314, a processor 316, a memory 318, and a network 320. The second device 370 may include a media memory application 372, a recording device 374, a processor 376, a memory 378, and a network 380. The media identification server may include a processor 332, a memory 334, and a network 338. In some embodiments, the memory 334 may include a media identification application 336. The storage server may include, a processor 352, a memory 354, and a network 358. In some embodiments, the memory 354 may include a database table storage 356. In some embodiments, the modules included in the first device 310, the second device 370, the media identification server 330, and the storage server 350 may be the same or substantially similar modules.

In some embodiments, the system 300 may begin working at step (1), where the first device 310 may sample a surrounding environment for an identifiable media using the recording device 314. In some embodiments, after the processor 316 may have detected an identifiable media, the system 300 may proceed to step (2). In step (2), the processor may send a fingerprint (e.g., fast Fourier transform, etc.) associated with the identifiable media to the media identification server 330. In some embodiments, the media identification server 330 receives the fingerprint via network 338, which may be connected to network 320.

After the media identification server 330 receives the fingerprint, the processor 332 may access memory 334. The processor 332 may use the media identification application 336 to analyze the fingerprint and identify the identifiable media. The system may then proceed to step (3), where the media identification server 330 may transmit the identity of the identifiable media to the first device 310. In some embodiments, the media identification server 330 and the first device 310 may communicate through networks 320 and 338.

Once the first device has received the identity of the identifiable media at step (3), the processor 316 may store the identity in the memory 318. In some embodiments, the system 300 may proceed to step (4), where the processor 316 may transmit the identity to the storage server 350. The first device 310 and storage sever 350 may communicate through networks 320 and 358. In some embodiments, the processor 352 may access the memory 354 in order to store the identity of the identifiable media in the form of a media record in a database table in the database table storage 356.

In some embodiments, the system 300 may proceed to step (5) where the second device 370, using the media memory application 372, may query for the identity of the identifiable media from the storage server 350. In some embodiments, the second device 370 and the storage server 350 may communicate through networks 380 and 358. In some embodiments, upon receiving the query, processor 352 may access the database table storage 356 and transmit the database table holding the identity of the identifiable media to the second device 379. In some embodiments, the processor 352 may transmit just the media record (e.g., the identity of the identifiable media) in the database table to the second device 379. In some embodiments, the first device 310 may be the same or substantially similar to the second device 370. In some embodiments, processor 376 may then store the database table in the memory 378.

For example, a mobile phone installed with a media memory application and owned by a user may use a microphone to sample for songs being played at a music festival. A processor in the mobile phone may detect a song. The processor may create a fingerprint (e.g. fast Fourier transform, etc.) of the song and transmit the fingerprint to a media identification server. The media identification server may use an application that uses the fingerprint to identify the song. The media identification server may then transmit the identity of the song back to the mobile device. The mobile device may stream the identity of the song to a storage server associated with the user (e.g., the user has an account to store information on the server) where the identity of the song may be stored as a media record on a database table. A tablet owned by the user may then years, months, days, and/or minutes later query the storage server for the identity of the song and receive the identity.

In some embodiments, the media identification server 330 and the storage sever 350 may be part of the same locally or remotely located server system. That is, the media identification application 336 may directly send the identity of an identifiable media to the database table storage 356. The identity does not need to be streamed back to the first device.

In some embodiments, the devices 310 and 370, and the networks 320, 380, 338 and 358 may contain commercially available or custom software (e.g., browser software, communications software, server software, natural language processing software, search engine and/or web crawling software, filter modules for filtering content based upon predefined parameters, etc.). In some embodiments, the networks 320, 380, 338, and 358 may be the same or substantially similar networks. In some embodiments the devices 310 and 370 may be desktops, laptops, or hand-held devices (e.g., cellphones, tablets, personal digital assistants, etc.).

In some embodiments, devices 310 and 370 may be configured to communicate with the servers 330 and 350 through networks 320, 380, 338 and 358. In some embodiments, the networks 320, 380, 338 and 358 may be modems or network interface cards. The devices 310 and 370 and servers 330 and 350 may be distant from each other and communicate over a networks 320, 380, 338 and 358. In some embodiments, the servers 330 and 350 may be central hubs from which the devices 310 and 370 can establish a communication connection, such as in a client-server networking model. Alternatively, the servers 330 and 350 and the devices 310 and 370 may be configured in any other suitable networking relationship (e.g., in a peer-to-peer configuration or using any other network topology).

In some embodiments, the networks 320, 380, 338, and 358 can be implemented using any number of any suitable communications media. For example, the networks 320, 380, 338, and 358 may be wide area networks (WANs), local area networks (LANs), apart of the Internet, or apart of an intranet. In certain embodiments, the devices 310 and 370 and servers 330 and 350 may be local to each other, and communicate via any appropriate local communication medium. For example, the devices 310 and 370 and the servers 330 and 350 may communicate using a local area network (LAN), one or more hardwire connections, a wireless link or router, or an intranet. In some embodiments, the devices 310 and 370 and the servers 330 and 350 may be communicatively coupled using a combination of one or more networks 320, 380, 338, 358, and/or one or more local connections. For example, the first device 310 may be hardwired to the storage sever 350 (e.g., connected with an Ethernet cable) while the second device 370 may communicate with the storage server 350 using the networks 380 and 358 (e.g., over the Internet).

In some embodiments, the networks 320, 380, 338, and 358 can be implemented within a cloud computing environment, or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the networks 320, 380, 338, and 358.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

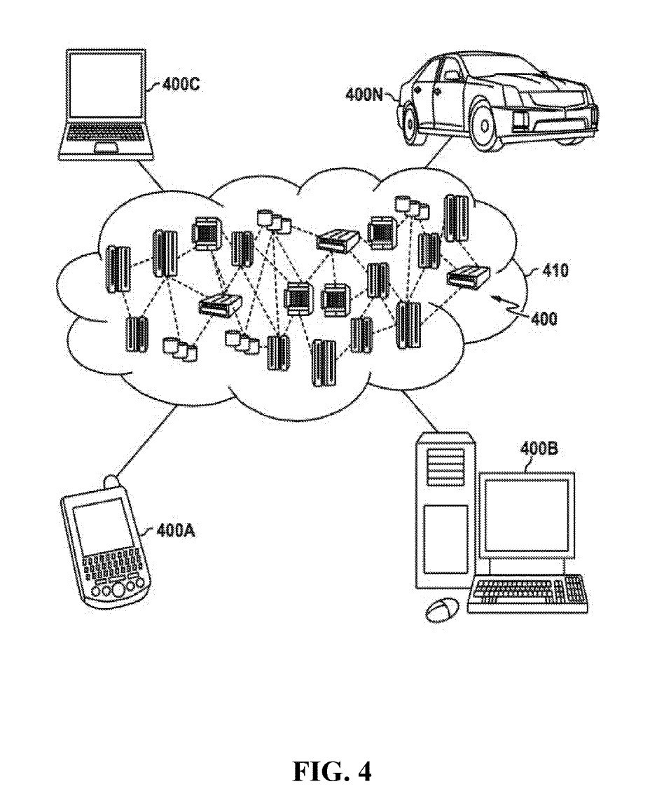

Referring now to FIG. 4, illustrative cloud computing environment 410 is depicted. As shown, cloud computing environment 410 includes one or more cloud computing nodes 400 with which local computing devices used by cloud consumers, such as, for example, personal digital assistant (PDA) or cellular telephone 400A, desktop computer 400B, laptop computer 400C, and/or automobile computer system 400N may communicate. Nodes 400 may communicate with one another. They may be grouped (not shown) physically or virtually, in one or more networks, such as Private, Community, Public, or Hybrid clouds as described hereinabove, or a combination thereof. This allows cloud computing environment 410 to offer infrastructure, platforms and/or software as services for which a cloud consumer does not need to maintain resources on a local computing device. It is understood that the types of computing devices 400A-N shown in FIG. 4 are intended to be illustrative only and that computing nodes 400 and cloud computing environment 410 can communicate with any type of computerized device over any type of network and/or network addressable connection (e.g., using a web browser).

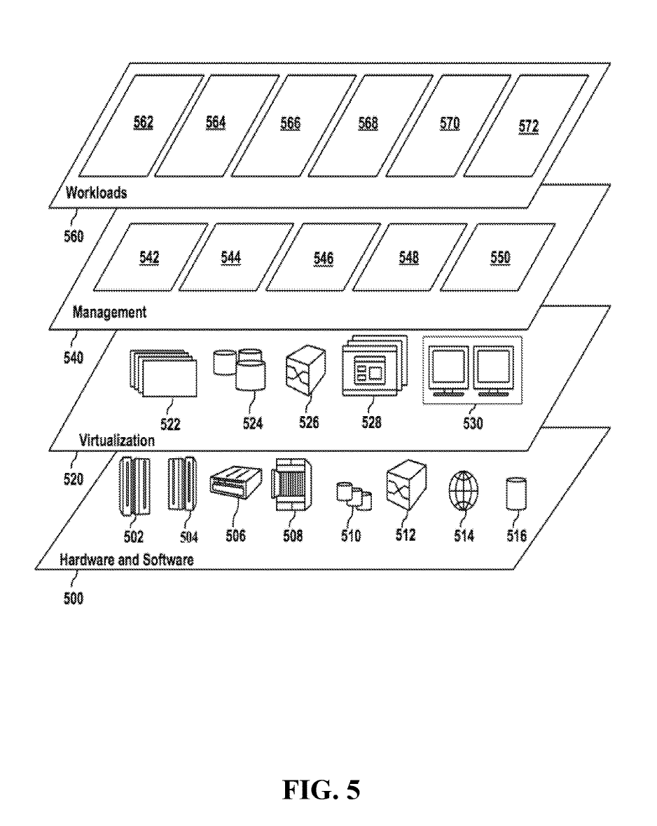

Referring now to FIG. 5, a set of functional abstraction layers provided by cloud computing environment 410 (FIG. 4) is shown. It should be understood in advance that the components, layers, and functions shown in FIG. 5 are intended to be illustrative only and embodiments of the invention are not limited thereto. As depicted below, the following layers and corresponding functions are provided.

Hardware and software layer 500 includes hardware and software components. Examples of hardware components include: mainframes 502; RISC (Reduced Instruction Set Computer) architecture based servers 504; servers 506; blade servers 508; storage devices 510; and networks and networking components 512. In some embodiments, software components include network application server software 514 and database software 516.

Virtualization layer 520 provides an abstraction layer from which the following examples of virtual entities may be provided: virtual servers 522; virtual storage 524; virtual networks 526, including virtual private networks; virtual applications and operating systems 528; and virtual clients 530.

In one example, management layer 540 may provide the functions described below. Resource provisioning 542 provides dynamic procurement of computing resources and other resources that are utilized to perform tasks within the cloud computing environment. Metering and Pricing 544 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 546 provides access to the cloud computing environment for consumers and system administrators. Service level management 548 provides cloud computing resource allocation and management such that required service levels are met. Service Level Agreement (SLA) planning and fulfillment 550 provide pre-arrangement for, and procurement of, cloud computing resources for which a future requirement is anticipated in accordance with an SLA.

Workloads layer 560 provides examples of functionality for which the cloud computing environment may be utilized. Examples of workloads and functions which may be provided from this layer include: mapping and navigation 562; software development and lifecycle management 564; virtual classroom education delivery 566; data analytics processing 568; transaction processing 570; and identifying an identifiable media 572.

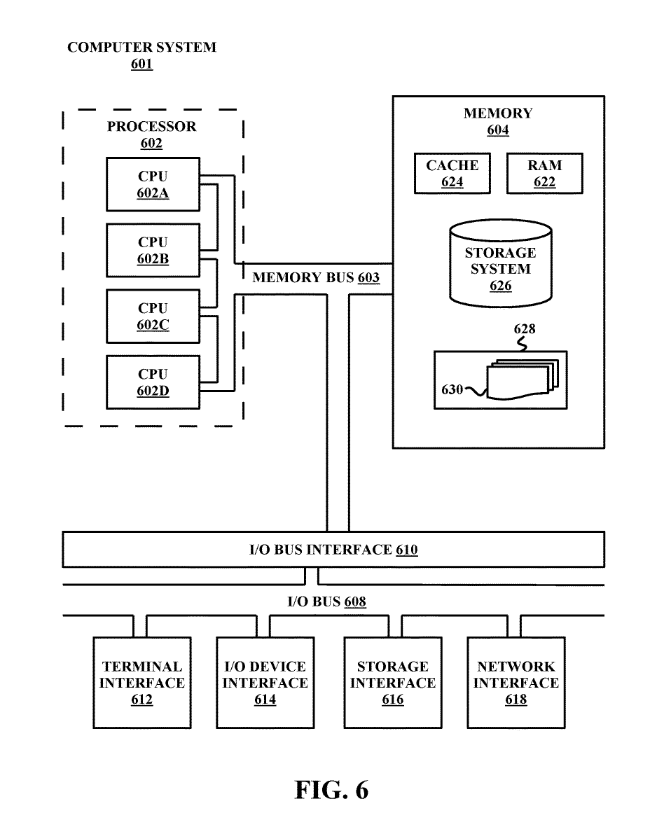

Referring now to FIG. 6, shown is a high-level block diagram of an example computer system 601 that may be used in implementing one or more of the methods, tools, and modules, and any related functions, described herein (e.g., using one or more processor circuits or computer processors of the computer), in accordance with embodiments of the present disclosure. In some embodiments, the major components of the computer system 601 may comprise one or more CPUs 602, a memory subsystem 604, a terminal interface 612, a storage interface 616, an I/O (Input/Output) device interface 614, and a network interface 618, all of which may be communicatively coupled, directly or indirectly, for inter-component communication via a memory bus 603, an I/O bus 608, and an I/O bus interface unit 610.

The computer system 601 may contain one or more general-purpose programmable central processing units (CPUs) 602A, 602B, 602C, and 602D, herein generically referred to as the CPU 602. In some embodiments, the computer system 601 may contain multiple processors typical of a relatively large system; however, in other embodiments the computer system 601 may alternatively be a single CPU system. Each CPU 602 may execute instructions stored in the memory subsystem 604 and may include one or more levels of on-board cache.

System memory 604 may include computer system readable media in the form of volatile memory, such as random access memory (RAM) 622 or cache memory 624. Computer system 601 may further include other removable/non-removable, volatile/non-volatile computer system storage media. By way of example only, storage system 626 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM or other optical media can be provided. In addition, memory 604 can include flash memory, e.g., a flash memory stick drive or a flash drive. Memory devices can be connected to memory bus 603 by one or more data media interfaces. The memory 604 may include at least one program product having a set (e.g., at least one) of program modules that are configured to carry out the functions of various embodiments.

One or more programs/utilities 628, each having at least one set of program modules 630 may be stored in memory 604. The programs/utilities 628 may include a hypervisor (also referred to as a virtual machine monitor), one or more operating systems, one or more application programs, other program modules, and program data. Each of the operating systems, one or more application programs, other program modules, and program data or some combination thereof, may include an implementation of a networking environment. Programs 628 and/or program modules 630 generally perform the functions or methodologies of various embodiments.

Although the memory bus 603 is shown in FIG. 6 as a single bus structure providing a direct communication path among the CPUs 602, the memory subsystem 604, and the I/O bus interface 610, the memory bus 603 may, in some embodiments, include multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 610 and the I/O bus 608 are shown as single respective units, the computer system 601 may, in some embodiments, contain multiple I/O bus interface units 610, multiple I/O buses 608, or both. Further, while multiple I/O interface units are shown, which separate the I/O bus 608 from various communications paths running to the various I/O devices, in other embodiments some or all of the I/O devices may be connected directly to one or more system I/O buses.

In some embodiments, the computer system 601 may be a multi-user mainframe computer system, a single-user system, or a server computer or similar device that has little or no direct user interface, but receives requests from other computer systems (clients). Further, in some embodiments, the computer system 601 may be implemented as a desktop computer, portable computer, laptop or notebook computer, tablet computer, pocket computer, telephone, smart phone, network switches or routers, or any other appropriate type of electronic device.

It is noted that FIG. 6 is intended to depict the representative major components of an exemplary computer system 601. In some embodiments, however, individual components may have greater or lesser complexity than as represented in FIG. 6, components other than or in addition to those shown in FIG. 6 may be present, and the number, type, and configuration of such components may vary.

As discussed in more detail herein, it is contemplated that some or all of the operations of some of the embodiments of methods described herein may be performed in alternative orders or may not be performed at all; furthermore, multiple operations may occur at the same time or as an internal part of a larger process.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Although the present invention has been described in terms of specific embodiments, it is anticipated that alterations and modification thereof will become apparent to the skilled in the art. Therefore, it is intended that the following claims be interpreted as covering all such alterations and modifications as fall within the true spirit and scope of the invention.

What is claimed is:

1. A computer-implemented method comprising:
sampling, by a processor, a surrounding environment for an identifiable media in response to an activation event;
determining, based on the sampling, whether an identifiable media was detected;
generating reference indicators from environmental conditions;
tagging the identifiable media with one or more reference indicators associated with the environmental conditions;
transmitting a segment of the identifiable media to a media identification application; and
receiving information about the identifiable media.

2. The method of claim 1, wherein the activation event includes a sampling rate, the method further comprising:
increasing the sampling rate of the surrounding environment in response to identifying the identifiable media, wherein the identifiable media is at least one object in the surrounding environment identified by the processor as having searchable media attributes.

3. The method of claim 1, wherein determining whether the identifiable media was detected further comprises:
identifying, by the processor, the identifiable media as a media with searchable media attributes, wherein the searchable media attributes include rhythm, beat, pitch, decibel level of noise, and audio-enhancement of voices.

4. The method of claim 1, wherein transmitting the segment of the identifiable media to the media identification application further comprises:
generating a fingerprint of searchable media attributes associated with the identifiable media.

5. The method of claim 4, further comprising:
transmitting one or more current environmental conditions to a remotely located server;
determining that at least one of the one or more reference indicators approximately matches one or more current environmental conditions; and
prompting a user to play a song on a device in response to determining that at least one of the one or more reference indicators approximately matches one or more current environmental conditions.

6. The method of claim 1, wherein tagging the identifiable media with reference indicators comprises marking a first identifiable media with a location indicator, a time indicator, and a date indicator.

7. The method of claim 1, wherein the activation event occurs when a timer set to activate a microphone at a predetermined time associated with a sampling rate expires.

8. The method of claim 1, wherein the activation event occurs when the processor activates a device in response to a gyroscope in the device detecting vibration in the surrounding environment.

9. The method of claim 1, further comprising:
storing the information about the identifiable media in a database table.

10. A system comprising:
a memory; and
a processor in communication with the memory, the processor being configured to perform operations comprising:
receiving, from a device, one or more reference indicators for an identifiable media and a segment of the identifiable media;
identifying the identifiable media with a media identification application, wherein the media identification application generates a name indicator for the identifiable media;
storing the one or more reference indicators associated with the identifiable media and the name indicator in a database table.

11. The system of claim 10, wherein the one or more reference indicators include a time indicator, a location indicator, and a date indicator.

12. The system of claim 10, wherein identifying the identifiable media with a media identification application further comprises:
receiving a searchable media attribute associated with the identifiable media, wherein the searchable media attribute is an acoustic fingerprint used to locate the name indicator associated with the identifiable media;
transmitting the searchable media attribute to the media identification application; and
receiving, from the media identification application, the name indicator for the identifiable media.

13. The system of claim 12, further comprising:
transmitting the name indicator to a media content provider; and
generating a playlist, wherein the playlist includes a list of the identifiable media.

14. The system of claim 13, further comprising:
receiving a current location indicator, a current time indicator, and a current date indicator from the device;
determining that at least one of the one or more reference indicators associated with the identifiable media approximately matches at least one of the current indicators received from the device; and
transmitting the playlist to the device.

15. The system of claim 14, wherein determining that at least one of the one or more reference indicators approximately matches at least one of the current indicators comprises:
comparing the current date, location, and time indicators to the date, location, and time indicators, respectively;
determining that the current date indicator is a same month and day as the date indicator, that the current location indicator is within a same geographically named area as the location indicator, or that the current time indicator is within one minute of the time indicator.

16. A computer program product comprising a computer readable storage medium having program instructions embodied therewith, the program instructions executable by a processor to cause the processor to perform a method, the method comprising:
sampling a surrounding environment for an identifiable media in response to an activation event;
determining, based on the sampling, whether an identifiable media was detected;
generating reference indicators from environmental conditions;
tagging the identifiable media with one or more reference indicators associated with the environmental conditions;
transmitting a segment of the identifiable media to a media identification application; and
receiving information about the identifiable media.

17. The computer program product of claim 16, wherein the activation event includes a sampling rate, the method further comprising:
increasing the sampling rate of the surrounding environment in response to identifying the identifiable media, wherein the identifiable media is at least one object in the surrounding environment identified by the processor as having searchable media attributes.

18. The computer program product of claim 16, wherein determining whether the identifiable media was detected further comprises:
identifying, by the processor, the identifiable media as a media with searchable media attributes, wherein the searchable media attributes include rhythm, beat, pitch, decibel level of noise, and audio-enhancement of voices.

19. The computer program product of claim 16, wherein transmitting the segment of the identifiable media to the media identification application further comprises:
generating a fingerprint of searchable media attributes associated with the identifiable media.

20. The computer program product of claim 19, further comprising:
transmitting one or more current environmental conditions to a remotely located server;
determining that at least one of the one or more reference indicators approximately matches one or more current environmental conditions; and
prompting a user to play a song on a device in response to determining that at least one of the one or more reference indicators approximately matches one or more current environmental conditions.
